(19) United States
(12) Patent Application Publication
(10) Pub. No.: US 2005/0169463 A1
(43) Pub. Date: Aug. 4, 2005

(54) Hardware cryptographic engine and hardware cryptographic method using an efficient S-BOX implementation

(76) Inventors: Kyoung-moon Ahn, Seoul (KR); Mi-jung Noh, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/024,855

(22) Filed: Dec. 30, 2004

(30) Foreign Application Priority Data
Jan. 29, 2004 (KR) 2004-5647

(51) Int. Cl. H04K 1/00

(52) U.S. Cl. 380/28

(57) ABSTRACT

A hardware cryptographic engine implementing an Advanced Encryption Standard (AES) algorithm is disclosed. The hardware cryptographic engine comprises a plurality of modules corresponding to rounds of AES. Each of the plurality of modules comprises an S-BOX computing a multiplicative inverse of each element in an input vector over GF(2⁸) using an operation over GF(((2²)²)²), and replacing each element of the input vector with a substitute element obtained using a result of the operation.

### BACKGROUND OF THE INVENTION

1. Field of the Invention

The present invention relates generally to a hardware cryptographic engine, and more particularly, to a hardware cryptographic engine implementing an Advanced Encryption Standard (AES) algorithm.

A claim of priority is made to Korean Patent Application No. 10-2004-0005647, filed on Jan. 29, 2004, the disclosure of which is incorporated herein by reference in its entirety.

2. Description of the Related Art

Users of a smart cards, integrated circuit (IC) cards, the internet, and wireless Local Area Networks (LANs) tend to transmit large amounts of secret information requiring secure communication links. Accordingly, a hardware cryptographic engine is generally provided to encrypt and transmit the secret information through a signature or authentication process in order to prevent the secret information from being viewed by unauthorized parties.

Due to the high computational cost of most encryption processes, encryption is typically performed by hardware rather than software in technologies such as smart cards. A symmetric key algorithm such as Data Encryption Standard (DES) or Advanced Encryption Standard (AES) is generally implemented in hardware in addition to a public key algorithm such as Rivest-Shamir-Adelman (RSA) or Elliptic Curve Crypto (ECC) system.

The AES algorithm has the structure of a Substitution Permutation Network (SPN). AES refers to a symmetric encryption algorithm permuting DES. AES uses a block length of 128 bits and key lengths of 128, 192 and 256 bits. Ten, twelve, or fourteen rounds of AES are executed according to the respective key length used. The AES encryption process comprises the summation of an initial input key with input data and the operation of each round.

Each round in the AES encryption process performs the same operations, except for a final round, which omits a data transformation. For example, where the number of rounds used in the AES encryption process is denoted as “Nr”, a round comprising operations labeled “Sub_Byte transformation”, “Shift_Row transformation”, “Mix_Column transformation”, and “Add_Round_Key operation” is performed (Nr-1) times, and a final round operation comprising “Sub_Byte transformation”, “Shift_Row transformation”, and “Add_Round_Key operation”, but not “Mix_Column transformation,” is performed once. Accordingly, in an implementation of the conventional AES encryption algorithm, at least (Nr+1) clock cycles are needed in an encryption process, and more than 2(Nr+1) clock cycles of are needed to perform both the encryption process and a decryption process which is the inverse of the encryption process. A round of the AES encryption algorithm as described above is disclosed in U.S. published patent application No.: 2003-0133568 or in Korean published patent application No.: 2002-061718.

“Sub_Byte transformation”, which is a non-linear transformation, is performed through the operation of an S-BOX. “Sub_Byte transformation” consumes the most power of any transformation in a conventional implementation of the AES algorithm. As a non-linear transformation function, the S-BOX substitutes input data with other data. The S-BOX causes high power consumption due to the complexity of a memory and a circuit used to implement the non-linear transformation function. For example, the S-BOX performs a substitution operation according to a non-linear function using various methods such as Look-up Table (LUT), Sum-of-Products (SOP), Product-of-Sum (POS), Positive Polarity Reed-Muller (PPRM) form, and Binary Decision Diagram (BDD). In order to obtain a transformed value for an input value of the S-BOX in a typical LUT implementation, values are stored as a LUT in a Read Only Memory (ROM). In implementations of the SOP, POS, PPRM form, and BDD methods and the like, data is expressed in binary notation using eight inputs.

One common drawback to conventional implementations of an S-BOX using the above methods is that they require about 800-2200 gates. The large number of required gates creates a problem for hardware applications having limited memory and bandwidth such as smart cards and IC cards. The large number of required gates is also inappropriate for miniature systems requiring low power consumption and fast operating speed.

### SUMMARY OF THE INVENTION

The present invention provides a hardware cryptographic engine performing a low power and high-speed cryptographic operation that is readily applied to a miniature system such as a smart card or an Integrated Circuit (IC) card.

According to one embodiment of the present invention, a hardware cryptographic engine is provided. The hardware cryptographic engine comprises; a plurality of modules connected in a sequence, a plurality of keys corresponding to the plurality of modules, and a key scheduler generating the plurality of keys using an input key. A first module in the plurality of modules receives a first key and input data and outputs cipher text, and each remaining module in the sequence receives a corresponding key and cipher text output by a previous module in the sequence and outputs cipher text. Each of the plurality of modules comprises an S-BOX computing a multiplicative inverse of each element in an input vector over GF(2⁸) using an operation over GF(((2²)²)²), and replaces each element in the input vector with a substitute element obtained using a result of the operation.

By computing the multiplicative inverse of each element in an input vector over GF(2⁸) using an operation over GF(((2²)²)²), the hardware cryptographic engine provides a low power, high speed implementation of the AES algorithm.

According to another embodiment of the present invention, a hardware cryptographic method is also provided. The hardware cryptographic method uses the hardware cryptographic engine to encrypt transmission data.

### BRIEF DESCRIPTION OF THE DRAWINGS

The accompanying drawings illustrate several selected embodiments of the present invention, and are incorporated in and constitute a part of this specification. Like reference numerals refer to like elements throughout the drawings and the written description. In the drawings:

FIG. 1 is a block diagram illustrating a hardware encryption device according to one exemplary embodiment of the present invention;

FIG. 2 is a detailed block diagram illustrating operations performed by modules 120 through 140 in FIG. 1;

FIG. 3 is a detailed block diagram illustrating operations performed by a module 150 in FIG. 1;

FIG. 4 is a block diagram illustrating a key scheduler used to generate keys in FIG. 1;

FIG. 5 is a detailed block diagram illustrating an S-BOX used in Sub-Byte circuits 160 and 200 in FIGS. 2 and 3;

FIG. 6 is a detailed block diagram illustrating an inverse operation unit 162 in FIG. 5 used to perform an inverse operation over GF(((2²)²)²);

FIG. 7 is a detailed block diagram illustrating a first inverse operator 605 in FIG. 6 used to perform an inverse operation over GF((2²)²);

FIG. 8 is a detailed block diagram illustrating 4-bit multipliers 602, 606 and 607 in FIG. 6 used to perform multiplication over GF((2²)²);

FIG. 9 is a detailed block diagram illustrating 2-bit multipliers 702, 707, 708, 803, 804 and 805 in FIGS. 7 and 8 used to perform multiplication over GF(2²);

FIG. 10 is an example of a hardware decryption device used to decrypt cipher text transmitted from the hardware encryption device in FIG. 1;

FIG. 11 is a detailed block diagram illustrating operations performed by modules 1200 through 1400 in the hardware decryption device in FIG. 10;

FIG. 12 is a detailed block diagram illustrating operations performed by a module 1500 in FIG. 10; and

FIG. 13 is a detailed block diagram illustrating an inverse S-BOX used in inverse Sub-Byte circuits 1700 and 2100 in FIGS. 11 and 12.

### DETAILED DESCRIPTION OF THE INVENTION

The present invention will now be described more fully with reference to the accompanying drawings, in which several exemplary embodiments of the invention are shown.

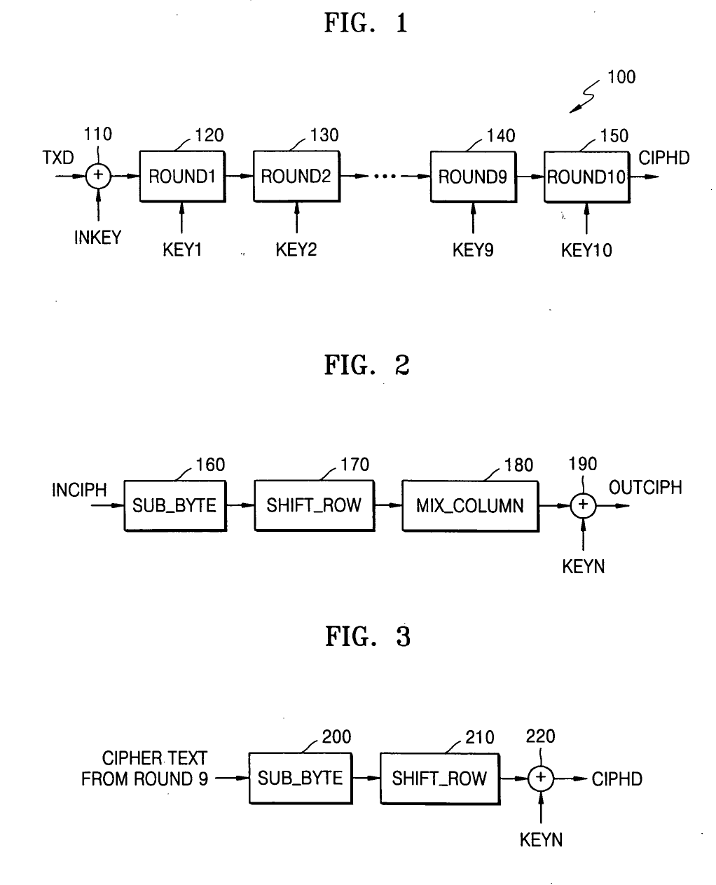

FIG. 1 is a block diagram illustrating a hardware encryption device 100 according to one exemplary embodiment of the present invention.

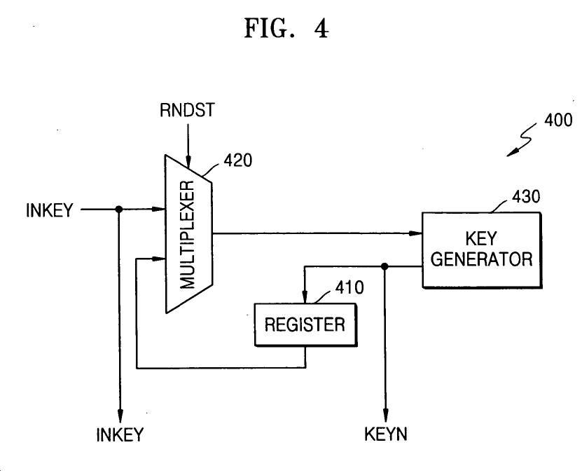

Referring to FIG. 1, hardware encryption device 100 implements an Advanced Encryption Standard (AES) algorithm. Hardware encryption device 100 comprises an adder 110 and a plurality of modules 120 through 150 corresponding to first through tenth rounds of the AES algorithm. Hardware encryption device 100 further comprises a key scheduler 400 as shown in FIG. 4. Key scheduler 400 provides an input key INKEY to adder 110 and keys KEY1 through KEY10 to modules 120 through 150. Key scheduler 400 is described in more detail in FIG. 4. In each of modules 120 through 150, a redundant operation is typically performed.

Adder 110 adds transmission data TXD to input key INKEY and outputs the result of the addition as input data for module 120. Transmission data TXD typically has a block length of 128 bits.

Modules 120 through 150 receive keys KEY1 through KEY10 corresponding to each module. Keys KEY1 through KEY10 typically have data lengths of 128 bits and accordingly, modules 120 through 150 typically comprise 10 modules, i.e. they correspond to 10 rounds performed in the AES algorithm. In cases where keys have data lengths of 192 bits or 256 bits, 12 and 14 respective rounds of AES are performed.

Module 120 transforms the output of adder 110 into cipher text using key KEY1. Accordingly, each of nine remaining modules 130 through 150 sequentially transform cipher text output by the previous module into other cipher texts using respective keys KEY2 through KEY10. Module 150 transforms cipher text output by module 140 into a final cipher text CIPHD using key KEY10. Final cipher text CIPHD is secret information transmitted by a miniature system such as a smart card or an IC card. Hardware cryptographic engine 100 is also used in internet communication, wireless LAN communication and the like to transmit and receive secret information requiring security.

In the above-described embodiment, since the number of rounds used in the AES encryption process is 10, rounds comprising “Sub_byte transformation”, “Shift_Row transformation”, “Mix_Column transformation”, and “Add_Round Key operation” are performed nine times, and a final round comprising “Sub_byte transformation”, “Shift_Row transformation”, and “Add_Round_Key operation”, but not “Mix_Column transformation”, is performed once.

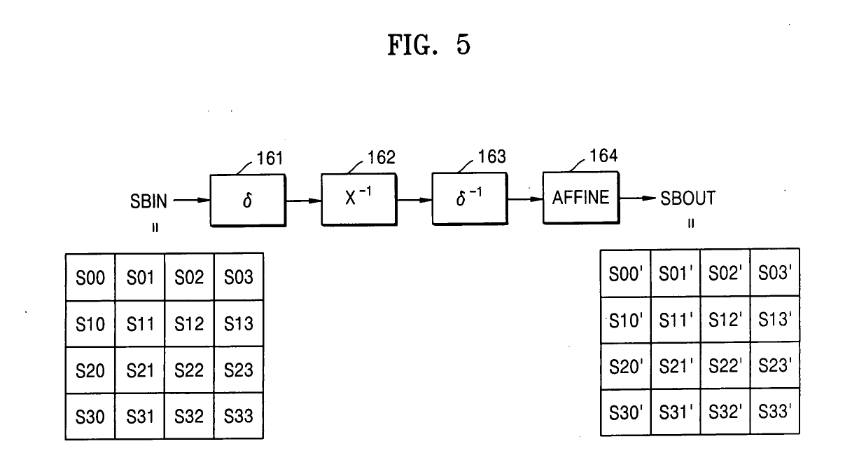

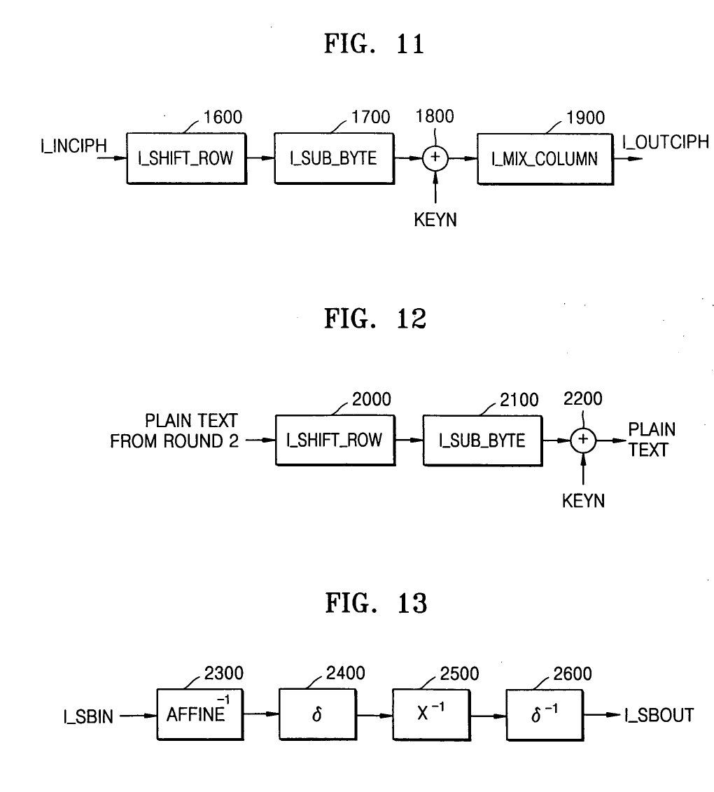

Generally, hardware encryption device 100 consumes a large amount of power due to the complexity of a memory and a circuit used to perform “Sub_Byte transformation”, which is a non-linear transformation. Accordingly, the present invention provides a hardware cryptographic engine having a new S-BOX shown in FIGS. 5 and 13. The new S-BOX is used in a Sub_Byte circuit 160 in FIG. 2, a Sub_Byte circuit 200 in FIG. 3, an inverse Sub_Byte circuit 1700 in FIG. 11, and an inverse Sub_Byte circuit 2100 in FIG. 12. The new S-BOX is used to perform “Sub_Byte transformation” and “inverse Sub_Byte transformation” in a manner different from conventional art.

According to an exemplary embodiment of the present invention, hardware encryption device 100 uses the S-BOX to replace each input element with its multiplicative inverse or reciprocal over GF(2⁸) using operations over composite fields of GF(2), i.e., GF(2²), GF((2²)²) and GF(((2²)²)²) . An operation of the S-BOX in FIG. 5 is described in more detail in FIGS. 2, 3 and 5.

FIG. 2 is a detailed block diagram illustrating operations performed by modules 120 through 140 in FIG. 1, which correspond to first through ninth rounds of the AES algorithm. Referring to FIG. 2, each of modules 120 through 140 comprises a Sub_Byte circuit 160, a Shift_Row circuit 170, a Mix_Column circuit 180, and an adder 190. As previously mentioned, during the first through ninth rounds of the AES algorithm, the operations “Sub_Byte transformation”, “Shift_Row transformation”, “Mix_Column transformation” and “Add_Round_Key operation” are performed at nine times.

Sub_Byte circuit 160 uses the S-BOX in FIG. 5 to perform an inverse operation over GF(2⁸) for “Sub_Byte transformation” by performing an operation over the composite field GF(((2²)²)²). In other words, the inverse operation over GF(2⁸) is performed by the operation over the composite fields of GF(2), i.e., GF(2²), GF((2²)²) and GF(((2²)²)²). Through the operation of the S-BOX, Sub_Byte circuit 160 replaces elements of an input vector INCIPH with substitute elements and outputs data resulting from the operation of the S-BOX as a Sub_Byte output vector.

For a fuller description of the inverse operation using the composite fields, refer to “A Compact Rijndael Hardware Architecture with S-BOX Optimization”, by Akashi Satoh, Sumio Morioka, Kohji Takano, and Seiji Munetoh, ASIACRYPT 2001.

According to a general communication standard, a primitive polynomial for each of GF(2⁸), GF(2²), GF((2²)²) and GF(((2²)²)²) is shown in Formula 1. The primitive polynomial in Formula 1 is an irreducible polynomial. λ={1100}₂ εGF((2²)²), and Ø={10}₂ εGF(2²). In other words, a first coefficient λ is a binary numeral {1100}₂ over GF((2²)²), and a second coefficient Ø is a binary numeral {10}₂ over GF(2²).

[Formula 1]
GF(2⁸): x⁸+x⁴+x³+x+1
GF(2²): x²+x+1
GF((2²)²): x²+x+Ø
GF(((2²)²)²): x²+x λ

In order to perform the operation “Shift_Row transformation”, Shift_Row circuit 170 receives the Sub_Byte output vector as an input vector. Shift_Row circuit 170 shifts the input vector according to a row-unit shift function and outputs the result as a Shift_Row output vector in a row unit.

In order to perform the operation “Mix_Column transformation”, Mix_Column circuit 180 permutes the Shift_Row output vector according to a column-unit permutation function and outputs the result as a Mix_Column output vector in a column unit.

In order to perform the operation “Add_Round_Key operation”, adder 190 adds the output vector of Mix_Column circuit 180 with a corresponding key KEYN among the keys and outputs the result of the addition as cipher text OUTCIPH. Cipher text OUTCIPH serves as input for a following module.

FIG. 3 is a detailed block diagram illustrating operations performed by module 150 corresponding to the tenth round in FIG. 1.

Referring to FIG. 3, module 150 comprises a Sub_Byte circuit 200, a Shift_Row circuit 210, and an adder 220. As previously mentioned, during the tenth and final round of the AES algorithm, the operations “Sub_Byte transformation”, “Shift_Row transformation”, and “Add_Round_Key operation” are performed once. The operations performed by Sub_Byte circuit 200, Shift_Row circuit 210, and adder 220 are the same as those performed by Sub_Byte circuit 160, Shift_Row circuit 170 and adder 190, respectively. Accordingly, their descriptions are omitted.

FIG. 4 is a block diagram illustrating key scheduler 400 used to generate keys KEY1 through KEY10 and input key INKEY in FIG. 1.

Referring to FIG. 4, key scheduler 400 comprises a register 410, a multiplexer 420, and a key generator 430.

In FIG. 4, input key INKEY is used for encryption, and is typically provided by the user. Key generator 430 generates key KEY1 to be used by module 120 using input key INKEY input through multiplexer 420. Key scheduler 400 provides adder 110 in FIG. 1 with input key INKEY at an initial time prior to the operation of module 120. Typically, input key INKEY is provided to adder 110 in FIG. 1 and key KEY1 is generated by key generator 430 during one cycle of a system clock (not shown). Key KEY1 generated by key generator 430 is stored in register 410, and at the same time, is input to module 120. Key KEY1 is input to multiplexer 420 from register 410 after one clock cycle. Multiplexer 420 selectively outputs input key INKEY, or key KEY1 output from the register 410, according to a logic state of a control signal RNDST. Where key KEY1 is input to key generator 430, key generator 430 generates and outputs key KEY2.

In other words, key generator 430 sequentially generates keys KEY2 through KEY10, which are respectively used by modules 130 though 150 in rounds two through ten, by using the key used in the previous round stored in register 410. For example, where key generator 430 receives key KEY1 from register 410 through multiplexer 420, key generator 430 uses key KEY1 to generate key KEY2, which is used by module 130 in the second round.

Key scheduler 400 generates each of keys KEY1 through KEY10 using input key INKEY as previously mentioned, thereby providing modules 120 through 150 corresponding to the ten rounds of the AES algorithm with corresponding keys KEY1 to KEY10. Since input key INKEY is provided to adder 110 in FIG. 1 and since keys KEY1 through KEY10 are sequentially generated by key generator 430, each using one cycle of the system clock as previously mentioned, ten clock-cycles are required to perform the AES encryption algorithm using the hardware encryption device shown in FIG. 1. Twenty clock-cycles are required to perform both the encryption process and the decryption process, which is the inverse of the encryption process. As described above, a minimal number of clock cycles are required to generate keys in the AES encryption process according to the present invention, thus providing fast operation. The decryption process is described in further detail in FIGS. 10 to 13.

FIG. 5 is a block diagram illustrating the S-BOX used in Sub-Byte circuits 160 and 200 in FIGS. 2 and 3.

Referring to FIG. 5, the S-BOX comprises an isomorphic transformation (ε) unit 161, an inverse operation (X⁻¹) unit 162, an inverse isomorphic transformation (ε⁻¹) unit 163 and an affine transformation unit 164.

Isomorphic transformation unit 161 performs an isomorphic transformation. Through the isomorphic transformation, an element over GF (2⁸) forming respective elements of an input vector SBIN is transformed into an element over GF(((2²)²)²), which is output by isomorphic transformation unit 161. Input vector SBIN has 128 bits, and is comprised of sixteen elements S00 to S33 having 8-bit data. The isomorphic transformation of isomorphic transformation unit 161 is shown in Equations 2 and 3 below.

[Equation 2]
y=6*x
where
x is an input vector to isomorphic transformation unit 161, and
y is a vector transformed by an isomorphic transformation vector ε.

$$δ = [ \begin{matrix}1 & 1 & 0 & 0 & 0 & 0 & 1 & 0 \\ 0 & 1 & 0 & 0 & 1 & 0 & 1 & 0 \\ 0 & 1 & 1 & 1 & 1 & 0 & 0 & 1 \\ 0 & 1 & 1 & 0 & 0 & 0 & 1 & 1 \\ 0 & 1 & 1 & 1 & 0 & 1 & 0 & 1 \\ 0 & 0 & 1 & 1 & 0 & 1 & 0 & 1 \\ 0 & 1 & 1 & 1 & 1 & 0 & 1 & 1 \\ 0 & 0 & 0 & 0 & 0 & 1 & 0 & 1\end{matrix} ] . \qquad [ Equation 3 ]$$

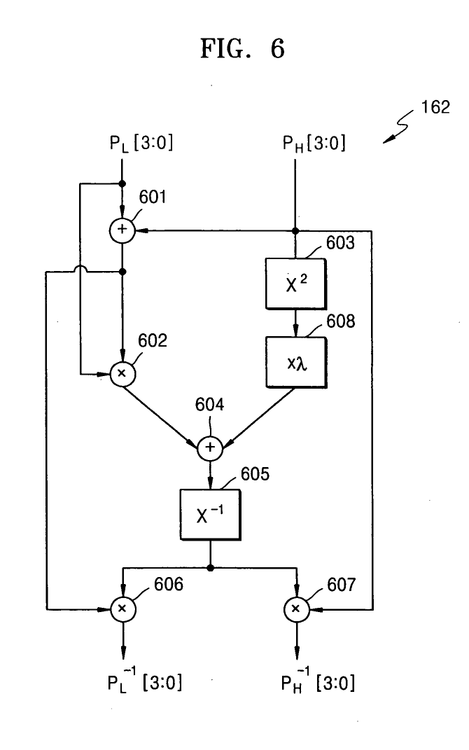

Inverse operation unit 162 operates on the element over GF(((2²)²)²) output by isomorphic transformation unit 161 and outputs the multiplicative inverse of the element over GF(((2²)²)²). The operation of inverse operation unit 162 is described in detail in FIG. 6.

Inverse isomorphic transformation unit 163 performs an inverse isomorphic transformation. Through the inverse isomorphic transformation, the multiplicative inverse of the element over GF(((2²)²)²) output by inverse operation unit 162 is transformed into an element over GF(2⁸), which is output by inverse isomorphic transformation unit 163. The transformation performed by inverse isomorphic transformation unit 163 is shown in Equations 4 and 5 below.

[Equation 4]
x=ε⁻¹*y
where
y is inverse vector input to inverse isomorphic transformation unit 163, and
x is a vector transformed by an inverse isomorphic transformation vector ε⁻¹.

$${δ}^{- 1} = [ \begin{matrix}1 & 0 & 1 & 0 & 1 & 1 & 1 & 0 \\ 0 & 0 & 0 & 0 & 1 & 1 & 0 & 0 \\ 0 & 1 & 1 & 1 & 1 & 0 & 0 & 1 \\ 0 & 1 & 1 & 1 & 1 & 1 & 0 & 0 \\ 0 & 1 & 1 & 0 & 1 & 1 & 1 & 0 \\ 0 & 1 & 0 & 0 & 0 & 1 & 1 & 0 \\ 0 & 0 & 1 & 0 & 0 & 0 & 1 & 0 \\ 0 & 1 & 0 & 0 & 0 & 1 & 1 & 1\end{matrix} ] \qquad [ Equation 5 ]$$

Affine transformation unit 164 performs an affine transformation for the element over GF(2⁸) output by inverse isomorphic transformation unit 163. As shown in FIG. 5, an affine-transformed vector SBOUT having 128 bits comprises sixteen elements S00′ to S33′ it having 8-bit data. Vector SBOUT has the same number of bits as vector SBIN input to isomorphic transformation unit 161. The affine transformation is shown in Equation 6 below.

$$[ \begin{matrix}{x}_{0}^{′} \\ {x}_{1}^{′} \\ {x}_{2}^{′} \\ {x}_{3}^{′} \\ {x}_{4}^{′} \\ {x}_{5}^{′} \\ {x}_{6}^{′} \\ {x}_{7}^{′}\end{matrix} ] = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}{x}_{0} \\ {x}_{1} \\ {x}_{2} \\ {x}_{3} \\ {x}_{4} \\ {x}_{5} \\ {x}_{6} \\ {x}_{7}\end{matrix} ] + [ \begin{matrix}1 \\ 1 \\ 0 \\ 0 \\ 0 \\ 1 \\ 1 \\ 0\end{matrix} ] \qquad [ Equation 6 ]$$

where

x₀ through x₇ are bit values for the element (8-bit data) over GF(2⁸) transformed by inverse isomorphic transformation unit 163, and

x′o through x′7 are bit values for the affine-transformed element (8-bit data).

FIG. 6 is a detailed block diagram illustrating inverse operation unit 162 in FIG. 5 used to perform the inverse operation over GF(((2²)²)²).

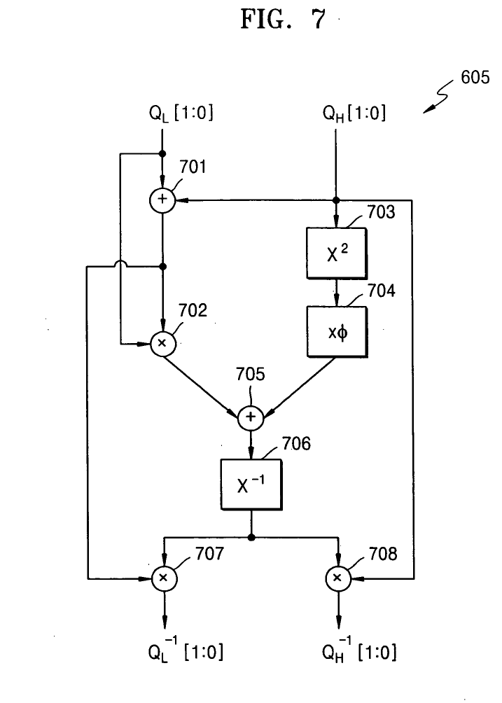

Referring to FIG. 6, inverse operation unit 162 comprises a first adder 601, a first multiplier 602, a first squarer 603, a first coefficient multiplier 608, a second adder 604, a first inverse operator 605, a second multiplier 606, and a third multiplier 607. First adder 601 adds upper 4-bit data P_{H}[3:0] and lower 4-bit data P_{L}[3:0] of 8-bit digital data output by isomorphic transformation unit 161 and outputs the result of the addition as a first sum. First multiplier 602 multiplies lower 4-bit data P_{L}[3:0] by the output of first adder 601 over GF((2²)²) and outputs the result of the multiplication as a first product. First squarer 603 receives upper 4-bit data P_{H}[3:0] and outputs the square of the upper 4-bit data P_{H}[3:0] as a first squared result. First coefficient multiplier 608 multiplies a first coefficient λ (from Formula 1) by the first squared result and outputs the result of the multiplication as a first coefficient product. Second adder 604 adds the first product with the output of first coefficient multiplier 608 and outputs the result of the addition as a second sum. First inverse operator 605 computes the inverse of the second sum over GF((2²)²) and outputs the result of the computation. The operation of first inverse operator 605 is described in further detail in FIG. 7.

Second multiplier 606 multiplies the output of first inverse operator 605 by the first sum over GF((2²)²) and outputs the result of the multiplication as a third product or as the inverse P_{L}⁻¹[3:0] of lower 4-bit data P_{L}[3:0]. Third multiplier 607 multiplies the output of first inverse operator 605 by the upper 4-bit data P_{H}[3:0] and outputs the result of the multiplication as a third product or as the inverse P_{H}⁻¹3:0] of upper 4-bit data P_{H}[3:0].

FIG. 7 is a detailed block diagram illustrating first inverse operator 605 in FIG. 6, which performs an inverse operation over GF((2²)²).

Referring to FIG. 7, first inverse operator 605 in FIG. 6 comprises a third adder 701, a fourth multiplier 702, a second squarer 703, a second coefficient multiplier 704, a fourth adder 705, a second inverse operator 706, a fifth multiplier 707, and a sixth multiplier 708. Third adder 701 adds upper 2-bit data Q_{H}[1:0] with lower 2-bit data Q_{L}[1:0] of 4-bit digital data forming the output of second adder 604 in FIG. 6 and outputs the result of the addition as a third sum. Fourth multiplier 702 multiplies the third sum by lower 2-bit data Q_{L}[1:0] over GF(2²) and outputs the result of the multiplication as a fourth product. Second squarer 703 squares upper 2-bit data Q_{H[}1:0] and outputs the result of the squaring operation as a second squared result. Second coefficient multiplier 704 multiplies the second squared result by a second coefficient Ø (from Formula 1) and outputs the result of the multiplication as a second coefficient product. Fourth adder 705 adds the fourth product with the second coefficient product and outputs the result of the addition as a fourth sum. Second inverse operator 706 computes the square of the fourth sum and outputs the result of the squaring as the inverse of the fourth sum. In other words, the square of the fourth sum is the same as its inverse. Fifth multiplier 707 multiplies the output of second inverse operator 706 by the third sum over GF(2²) and outputs the result of the multiplication as a fifth product or as the inverse Q_{L}⁻¹[1:0] of lower 2-bit data Q_{L}[1:0 ]. Sixth multiplier 708 multiplies the output of second inverse operator 706 by upper 2-bit data Q_{H}[1:0] over GF(2²) and outputs the result of the multiplication as a sixth product or as the inverse Q_{H}⁻¹[1:0] of upper 2-bit data Q_{H}[1:0].

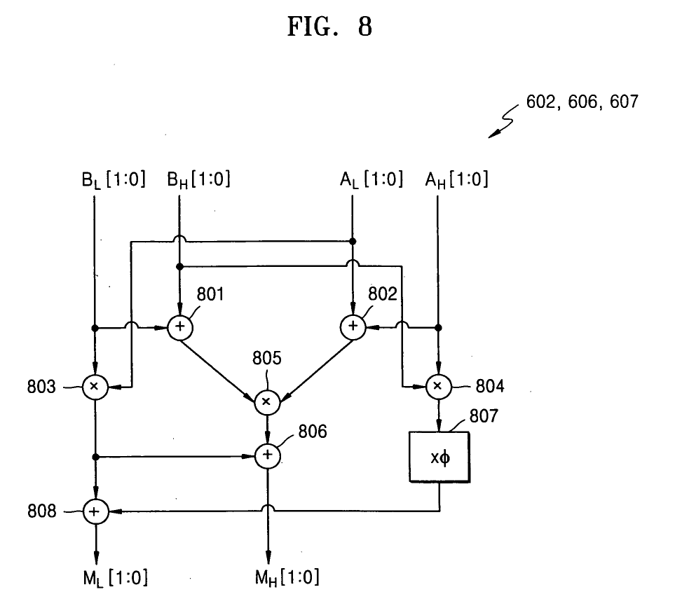

FIG. 8 is a detailed block diagram illustrating 4-bit multipliers 602, 606, and 607 in FIG. 6 used to perform multiplication over GF((2²)²).

Referring to FIG. 8, 4-bit multipliers 602, 606 and 607 of FIG. 6 each comprise a fifth adder 801, a sixth adder 802, a seventh multiplier 803, an eighth multiplier 804, a ninth multiplier 805, a seventh adder 806, a third coefficient multiplier 807, and an eighth adder 808. 4-bit multipliers 602, 606 and 607 receive two 4-bit digital data as a first operand A and a second operand B to compute a multiplication result M of the two 4-bit digital data over GF((2²)²). Fifth adder 801 adds upper 2-bit data B_{H}[1:0] with lower 2-bit data B_{L}[1:0] of second data B and outputs the result of the addition as a fifth sum. Sixth adder 802 adds upper 2-bit data A_{H}[1:0] with lower 2-bit data A_{L}[1:0] of first data A and outputs the result of the addition as a sixth sum. Seventh multiplier 803 multiplies lower 2-bit data B_{L}[1:0] of second data B by lower 2-bit data A_{L}[1:0] of first data A over GF(2²) and outputs the result of the multiplication as a seventh product. Eighth multiplier 804 multiplies upper 2-bit data B_{H}[1:0] of second data B by upper 2-bit data A_{H}[1:0] of the first data A and outputs the result of the multiplication as an eighth product. Ninth multiplier 805 multiplies the fifth sum by the sixth sum over GF(2²) and outputs the result of the multiplication as a ninth product. Seventh adder 806 adds the ninth product with the seventh product and outputs the result of the multiplication as upper 2-bit data M_{H}[1:0] of 4-bit multiplication result M. Third coefficient multiplier 807 multiplies the eighth product by second coefficient Ø (from Formula 1) and outputs the result of the multiplication as a third coefficient product. Eighth adder 808 adds the seventh product with the third coefficient product and outputs the result of the addition as lower 2-bit data M_{L}[1:0] of 4-bit data multiplication result M.

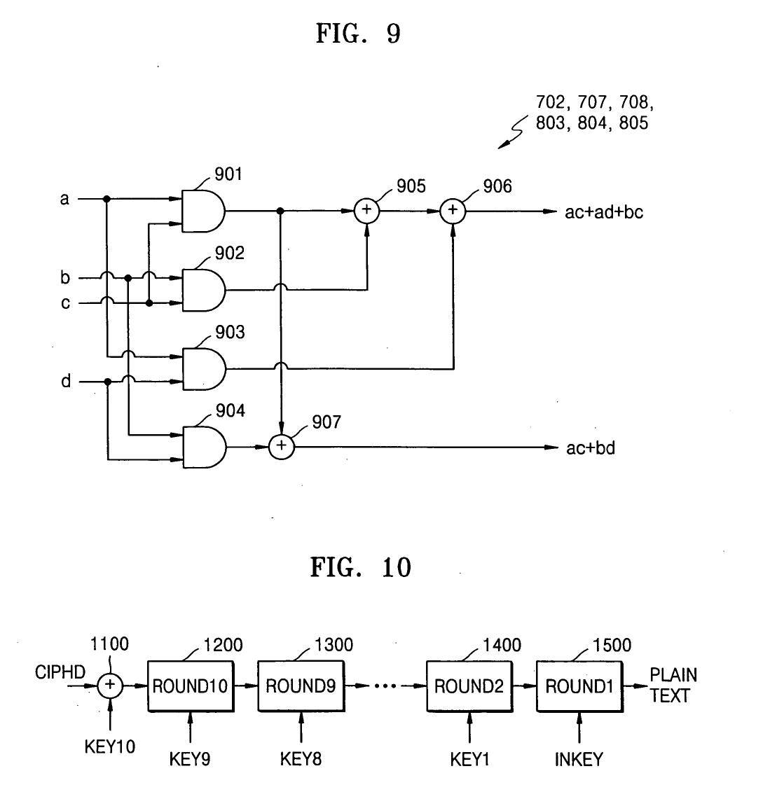

FIG. 9 is a detailed block diagram illustrating 2-bit multipliers 702, 707, 708, 803, 804 and 805 in FIGS. 7 and 8, which perform multiplication over GF(2²).

Referring to FIG. 9, 2-bit multipliers 702, 707, 803, 804, and 805 in FIGS. 7 and 8 each comprise a first AND gate 901, a second AND gate 902, a third AND gate 903, a fourth AND gate 904, a first exclusive OR gate 905, a second exclusive OR gate 906, and a third exclusive OR gate 907. 2-bit multipliers 702, 707, 708, 803, 804 and 805 each receive two 2-bit digital data as third operand C and fourth operand D to compute the multiplication result of the two 2-bit digital data over GF(2²). The result of multiplying operands C and D is computed using Equation 7. In other words, Equation 7 is obtained by denoting third operand C as “ax+b” and fourth operand D as “cx+d”. Since a primitive polynomial is denoted as “x2+x+1” over GF(2²) and the primitive polynomial is an irreducible polynomial in Formula 1, “x²” is equal to “x+1”, as in Equation 7 below.

$$\begin{matrix}( ax + b ) ( cx + d ) = acx 2 + adx + bcx + bd \\ = a c ( x + 1 ) + adx + bcx + bd \\ = ( a c + ad + bc ) x + ( a c + bd )\end{matrix} \qquad [ Equation 7 ]$$

where

a, c: upper bit data among 2-bit data, and

b, d: lower bit data among 2-bit data.

Accordingly, 2-bit multipliers 702, 707, 708, 803, 804 and 805 compute the multiplication result as follows. First AND gate 901 computes the logical product of upper bit data “a” and “c” of third operand C and fourth operand D and outputs the result “ac” of the computation as a first logical product. Second AND gate 902 computes the logical product of lower bit “b” of third data C and upper bit “c” of fourth data D and outputs the result “bc” of the computation as a second logical product. Third AND gate 903 computes the logical product of upper bit “a” of third data C and lower bit “d” of fourth data D and outputs the result “ad” of the computation as a third logical product. Fourth AND gate 904 computes the logical product of lower bits “b” and “d” of third data C and the fourth data D and outputs the result “bd” of the computation as a fourth logical product. First exclusive OR gate 905 computes the exclusive OR function for the output “ac” of first AND gate 901 and the output “bc” of second AND gate 902 and outputs the result “ac+bc” of the computation as a first XOR output. Second exclusive OR gate 906 computes the exclusive OR function for output “ac+bc” of first exclusive OR gate 905 and output “ad” of third AND gate 903 and outputs the result “ac+ad+bc” of the computation as upper bit data of the multiplication result. Third exclusive OR gate 907 computes the exclusive OR function for the output of first AND gate 901 and fourth AND gate 904 and outputs the result “ac+bd” of the computation as lower bit data of the multiplication result.

FIG. 10 is an example of a hardware decryption device used to decrypt cipher text transmitted by the hardware encryption device in FIG. 1.

Referring to FIG. 10, the hardware decryption device receives cipher text CIPHD transmitted from hardware encryption device 100 in FIG. 1, and decrypts the cipher text into plain text using an input key INKEY provided by a user. The plain text output by the hardware decryption device is secret information or authentication/signature data, which is transmitted across a system such as a smart card, an IC card, the internet, a wireless LAN, etc. In the decryption process, the AES encryption process described above is performed in reverse. In the case where hardware encryption device 100 performs ten rounds of AES as shown in FIG. 1, the hardware decryption device performs an additional ten rounds in the reverse of the encryption process, making twenty rounds total. The hardware decryption device uses an adder 1100 and modules 1200 through 1500 corresponding to rounds 10 through 1. Plain text is output by module 1500. Where decryption is performed, keys INKEY and KEY1 through KEY10 are used in a reverse sequence from that used in encryption.

Key scheduler 400 uses the input key INKEY to generate keys KEY1 to KEY10 for decryption in the same manner as in the encryption process. Once key KEY10 is generated, the decryption process is performed as shown in FIG. 10. Key scheduler 400 generates keys KEY9 through INKEY, which are used at each of the rounds 10 through 1. Altogether, 20 cycles of the system clock are needed to perform both the 10 round encryption process and the 10 round decryption process described above.

FIG. 11 is a detailed block diagram illustrating modules 1200 through 1400 corresponding to the tenth through second rounds, as shown in the hardware decryption device in FIG. 10.

Referring to FIG. 11, modules 1200 through 1400 (shown in FIG. 10) transform cipher text I_INCIPH using an operation labeled “inverse Shift_Row transformation” in an inverse Shift_Row circuit 1600. Cipher text I_INCIPH is further transformed by an operation labeled “inverse Sub_Byte transformation” in an inverse Sub_Byte circuit 1700. An adder 1800 adds an output from Sub_Byte circuit 1700 with a corresponding key KEYN and outputs the result of the addition. A final operation labeled “inverse Mix_Column transformation” transforms the result of the addition in an inverse Mix_Column circuit 1900, which outputs the result of the transformation as cipher text I_OUTCIPH.

FIG. 12 is a detailed block diagram illustrating module 1500 in FIG. 10.

Referring to FIG. 12, module 1500 in FIG. 10 comprises an inverse Shift_Row circuit 2000, an inverse Sub_Byte circuit 2100, and an adder 2200. Module 1500, which corresponds to a final round in the decryption process, performs a round comprising operations labeled “inverse Shift_Row transformation”, “inverse Sub_Byte transformation”, and “Add_Round_Key operation.”

FIG. 13 is a block diagram illustrating an inverse S-BOX used in inverse Sub-Byte circuits 1700 and 2100 in FIGS. 11 and 12.

Referring to FIG. 13, the inverse S-BOX performs a transformation which is the inverse of the transformation performed by the S-BOX in FIG. 5. The inverse S-BOX uses an inverse affine transformation unit 2300, an isomorphic transformation (ε) unit 2400, an inverse operation unit 2500, and an inverse isomorphic transformation (ε⁻¹) unit 2600.

The inverse transformation process of FIGS. 10 through 13 can be fully understood and implemented in hardware by those skilled in the art. Accordingly, a detailed description of the inverse transformation process is omitted.

As described above, in the AES hardware cryptographic engine, the S-BOX in FIG. 5 performing the operation “Sub_Byte transformation” computes the multiplicative inverse of an element over GF(2⁸) by using an operation over the composite field GF(((2²)²)²). Furthermore, the hardware cryptographic engine does not waste clock cycles when the initial round key is generated. The hardware cryptographic engine employs an optimized key scheduler 400 to generate a key KEYN, which is used at each round, during every clock cycle. Accordingly, the S-BOX in FIG. 5 or the inverse S-BOX in FIG. 13 has a size of about 400 gates, thereby reducing the hardware load, and also reducing the number of clock cycles needed to compute the non-linear transformation function. The operations performed by the S-BOX in FIG. 5 or the inverse S-BOX in FIG. 13 are performed in ten, twelve or fourteen rounds according to a variable length of respective keys, which can be either 128, 192, or 256 bits.

As described above, in the hardware cryptographic engine, a hardware area occupied by the S-BOX and a number of clock cycles required to generate keys for the AES encryption algorithm is minimized. Accordingly, the present invention provides an advantage in that it is readily applied to miniature systems such as a smart cards or an IC cards, which require a small hardware area and a fast operating speed.

The preferred embodiments disclosed in the drawings and the corresponding written description are teaching examples. Those of ordinary skill in the art will understand that various changes in form and details may be made to the exemplary embodiments without departing from the scope of the present invention which is defined by the following claims.

1. A hardware cryptographic engine comprising:
a plurality of modules connected in a sequence;
a plurality of keys corresponding to the plurality of modules; and,
and a key scheduler generating the plurality of keys;
wherein a first module in the plurality of modules receives a first key and input data and outputs cipher text, and each remaining module in the plurality of modules receives a corresponding key and cipher text output by a previous module in the sequence and outputs cipher text; and,
wherein each of the plurality of modules comprises an S-BOX computing a multiplicative inverse of each element in an input vector over GF(2⁸) using an operation over GF(((2²)²)²), and replacing each element in the input vector with a substitute element obtained using a result of the operation.

2. The hardware cryptographic engine of claim 1, wherein the key scheduler generates the plurality of keys in relation to an input key; and,
wherein the hardware cryptographic engine further comprises:
an adder which adds transmission data with the input key and outputs a resulting sum as the input data.

3. The hardware cryptographic engine of claim 1, wherein the plurality of modules comprises 10 modules.

4. The hardware cryptographic engine of claim 1, wherein the plurality of modules comprises 12 modules.

5. The hardware cryptographic engine of claim 1, wherein the plurality of modules comprises 14 modules.

6. The hardware cryptographic engine of claim 1, wherein each of the plurality of modules, except for a final module, comprises:
a Sub_Byte circuit receiving an input to the module and using the S-BOX to produce a Sub_Byte output vector;
a Shift_Row circuit receiving the Sub_Byte output vector and shifting the Sub_Byte output vector in a row unit according to a row-unit shift function and outputting the result of the row-unit shift function as a Shift_Row output vector;
a Mix_Column circuit permuting the Shift_Row output vector in a column unit according to a column-unit permutation function and outputting the result of the column-unit permutation as a Mix_Column output vector; and,
an adder adding the Mix_Column output vector with a key corresponding to the module and outputting a resulting sum; and,
wherein the final module comprises:
a Sub_Byte circuit receiving an input to the module and using the S-BOX to produce a Sub_Byte output vector;
a Shift_Row circuit receiving the Sub_Byte output vector and shifting the Sub_Byte output vector in a row unit according to a row-unit shift function and outputting the result of the row-unit shift function as a Shift_Row output vector; and,
an adder adding the Shift_Row output vector with a key corresponding to the module and outputting a resulting sum.

7. The hardware cryptographic engine of claim 1, wherein the S-BOX comprises:
an isomorphic transformation unit transforming an element over GF(2⁸), into an element over GF(((2²)²)²);
an inverse operation unit computing an inverse of the element over GF(((2²)²)²);
an inverse isomorphic transformation unit transforming the inverse of the element over GF(((2²)²)²) into a transformed element over GF(2⁸); and,
an affine transformation unit transforming the transformed element over GF(2⁸) according to an affine function.

8. The hardware cryptographic engine of claim 7, wherein the inverse operation unit comprises:
a first adder adding upper 4-bit data and lower 4-bit data of 8-bit digital data forming the element over GF(((2²)²)²) and outputting a first sum;
a first multiplier multiplying the first sum by the lower 4-bit data over GF((2²)²) and outputting a first product;
a first squarer squaring the upper 4-bit data and outputting a first squared result;
a first coefficient multiplier multiplying the first squared result by a first coefficient and outputting a first coefficient product;
a second adder adding the first product with the first coefficient product and outputting a second sum;
a first inverse operator computing an inverse of the second sum over GF((2²)²);
a second multiplier multiplying the inverse of the second sum over GF((2²)²) by the first sum over GF((2²)²) and outputting a second product as an inverse of the lower 4-bit data; and,
a third multiplier multiplying the inverse of the second sum over GF((2²)²) by the upper 4-bit data over GF((2²)²) and outputting a third product as an inverse of the upper 4-bit data.

9. The hardware cryptographic engine of claim 8, wherein the first inverse operator comprises:
a third adder adding upper 2-bit data and lower 2-bit data of 4-bit digital data forming the second sum and outputting a third sum;
a fourth multiplier multiplying the third sum by the lower 2-bit data over GF(2²) and outputting a fourth product;
a second squarer squaring the upper 2-bit data and outputting a second squared result;
a second coefficient multiplier multiplying the second squared result by a second coefficient and outputting a second coefficient product;
a fourth adder adding the fourth product and the second coefficient product and outputting a fourth sum;
a second inverse operator computing a square of the fourth sum as an inverse of the fourth sum;
a fifth multiplier multiplying the inverse of the fourth sum by the third sum over GF(2²) and outputting a fifth product as an inverse of the lower 2-bit data; and,
a sixth multiplier multiplying the inverse of the fourth sum by the upper 2-bit data over GF(2²) and outputting a sixth product as an inverse of the upper 2-bit data.

10. The hardware cryptographic engine of claim 8, wherein each of the first, second, and third multipliers comprises:
a fifth adder adding upper 2-bit data and lower 2-bit data of a second input operand having 4 bits and outputting a fifth sum;
a sixth adder adding upper 2-bit data and lower 2-bit data of a first input operand having 4 bits and outputting a sixth sum;
a seventh multiplier multiplying the lower 2-bit data of the first input operand and the second input operand over GF(2²) and outputting a seventh product;
an eighth multiplier multiplying upper 2-bit data of the first input operand and the second input operand over GF(2²) and outputting an eighth product;
a ninth multiplier multiplying the fifth sum by the sixth sum over GF(2²) and outputting a ninth product;
a seventh adder adding the ninth product with the seventh product and outputting a seventh sum as upper 2-bit data of a 4-bit multiplication result;
a second coefficient multiplier multiplying the eighth product by a second coefficient and outputting a second coefficient product; and,
an eighth adder adding the seventh product with the second coefficient product and outputting an eighth sum as lower 2-bit data of the 4-bit multiplication result.

11. The hardware cryptographic engine of claim 9, wherein each of the fourth, fifth, and sixth multipliers comprises:
a first AND gate computing the logical product of an upper bit of a first input operand having 2 bits and an upper bit of a second input operand having 2 bits and outputting a first logical product;
a second AND gate computing the logical product of a lower bit of the first input operand and the upper bit of the second input operand and outputting a second logical product;
a third AND gate computing the logical product of the upper bit of the first input operand and a lower bit of the second input operand and outputting a third logical product;
a fourth AND gate computing the logical product of the lower bit of the first input operand and the lower bit of the second input operand and outputting a fourth logical product;
a first exclusive OR gate computing the exclusive OR function of the first logical product and the second logical product and outputting a first XOR output;
a second exclusive OR gate computing the exclusive OR function of the first XOR output and the third logical product and outputting an upper bit for a 2-bit multiplication result; and,
a third exclusive OR gate computing the exclusive OR function of the first logical product and the fourth logical product and outputting a lower bit for the 2-bit multiplication result.

12. The hardware cryptographic engine of claim 10, wherein each of the seventh, eighth, and ninth multipliers comprises:
a first AND gate computing the logical product of an upper bit of a third input operand having 2 bits and an upper bit of a fourth input operand having 2 bits and outputting a first logical product;
a second AND gate computing the logical product of a lower bit of the third input operand and the upper bit of the fourth input operand and outputting a second logical product;
a third AND gate computing the logical product of the upper bit of the third input operand and a lower bit of the fourth input operand and outputting a third logical product;
a fourth AND gate computing the logical product of the lower bit of the third input operand and the lower bit of the fourth input operand and outputting a fourth logical product;
a first exclusive OR gate computing the exclusive OR function of the first logical product and the second logical product and outputting a first XOR output;
a second exclusive OR gate computing the exclusive OR function of the first XOR output and the third logical product and outputting an upper bit for a 2-bit multiplication result; and,
a third exclusive OR gate computing the exclusive OR function of the first logical product and the fourth logical product and outputting a lower bit for the 2-bit multiplication result.

13. The hardware cryptographic engine of claim 2, wherein the key scheduler generates the first key using the input key, and sequentially generates the keys corresponding to the plurality of modules;
wherein a previous key stored in a register is used to generate each key after the first key; and,
wherein the input key is provided to the adder and the first key is generated in one cycle of a system clock.

14. The hardware cryptographic engine of claim 1, wherein the key scheduler comprises:
a multiplexer receiving the input key and an output from a register and selectively outputting one of the received signals based on a control signal; and,
a key generator receiving the output from the multiplexer and generating and outputting a key, which is received by the register.

15. A hardware cryptographic method comprising:
generating a plurality of keys corresponding to a plurality of sequentially arranged modules using an input key;
transforming input data into cipher text using a first module from the plurality of modules and a first key from the plurality of keys and outputting the cipher text; and,
sequentially transforming the cipher text output by the first module using remaining modules in the plurality of modules and their corresponding keys;
wherein transforming the input data into cipher text comprises:
receiving the input data as an input vector in an S-BOX;
computing a multiplicative inverse of each element in the input vector over GF(2⁸) using an operation over GF(((2²)²)²) and replacing each element in the input vector with a substitute element obtained using the result of the operation.

16. The hardware cryptographic method of claim 15, further comprising adding transmission data to the input key and outputting a resulting sum as the input data.

17. The hardware cryptographic method of claim 15, wherein the plurality of modules comprises 10 modules.

18. The hardware cryptographic method of claim 15, wherein sequentially transforming the cipher text output by the first module into other cipher texts comprises:
receiving an input signal as an input vector in an S-BOX, performing an S-BOX operation, and outputting a result of the S-BOX operation;
shifting the result of the S-BOX operation in a row unit according to a row-unit shift function and outputting a shift result vector;
permuting the shift result vector, which is shifted in the row unit, in a column unit according to a column-unit permutation function and outputting a column-unit permuted vector; and,
adding the column-unit permuted vector with a corresponding key among the keys and outputting a resulting sum as an input signal for a following module;
wherein a final transformation of cipher text comprises:
receiving an input signal as an input vector in a final S-BOX, performing a final S-BOX operation, and outputting a result of the final S-BOX operation;
shifting the result of the final S-BOX operation in a row unit according to a row-unit shift function and output a final shift result vector; and,
adding the final shift result vector with a corresponding key among the keys and outputting a result of the addition as cipher text.

19. The hardware cryptographic method of claim 15, wherein replacing each element in the input vector with a substitute element comprises:
transforming each element in the input vector over GF(2⁸) into an element over GF(((2²)²)²);
computing and outputting the multiplicative inverse of the element over GF(((2²)²)²);
transforming the multiplicative inverse of the element over GF(((2²)²)²) into a transformed element over GF(2⁸); and,
transforming the transformed element over GF(2⁸) according to an affine function.

20. The hardware cryptographic method of claim 19, wherein, in computing the inverse of the element over GF(((2²)²)²), 8-bit digital data forming the element over GF(((2²)²)²) is divided into lower 4-bit data and upper 4-bit data in order to compute an inverse of the upper and lower 4-bit data over GF((2²)²) using a simple addition and multiplication.

21. The hardware cryptographic method of claim 20, wherein, in computing the inverse of the element over GF((2²)²), upper and lower 4-bit data forming the element over GF((2²)²) is divided into lower 2-bit data and upper 2-bit data in order to compute an inverse of the upper and lower 2-bit data over GF(2²) using simple addition and multiplication.

22. The hardware cryptographic method of claim 16, wherein generating the keys comprises:
generating the first key using the input key; and,
sequentially generating remaining keys in the plurality of keys using a key used by a previous module in the sequence stored in a register; and,
wherein providing the input key to the adder and generating the first key are performed in one cycle of a system clock.
